(19) United States
(12) Patent Application Publication
(10) Pub. No.: US 2021/0286236 A1
(43) Pub. Date: Sep. 16, 2021

(54) FULL PERIPHERY IMAGE OF SUBJECT TAKING DEVICE FOR FORMING 3D IMAGE PROFILE THEREFOR

(71) Applicant: Cubic Inc, Nagoya-shi, Aichi (JP)

(72) Inventor: Nobuharu Kato, Nagoya-shi, Aichi (JP)

(21) Appl. No.: 16/332,457

(22) PCT Filed: Aug. 29, 2017
(86) PCT No.: PCT/JP2017/030854

§ 371 Date: Mar. 12, 2019

(51) Int. Cl. G03B 17/56; G03B 35/02; H04N 13/254; H04N 13/296; H04N 13/221

(52) U.S. Cl. CPC G03B 17/561; G03B 35/02; H04N 13/221; H04N 13/296; H04N 13/254

(57) ABSTRACT

The image taking device for taking full periphery of a subject to be image-taken includes a rotating arm unit having a base plate and a rotating arm which is rotatably attached to the base plate, a subject to be image-taken unit fixed to a central portion of the base plate of the rotating arm unit and positioning the subject to be image taken thereon, an image taking unit including an image taking device attached to one end of the rotating arm and rotatable with the rotating arm and a backscreen attached to the other end of the rotating arm so that a background of the subject to be image-taken is interrupted from image taking by the image taking device. Thus, the image of the subject to be image-taken, which periphery is consecutively taken with seventy percent (%) or more thereof being overlapped, can be obtained by taking the image of the periphery of the subject to be image-taken by an image taking device, stopping per every predetermined rotational angle, while rotating about the subject to be image-taken.

### TECHNICAL FIELD

Recently, as, a method for forming a three dimensional (3D) profile of a subject to be image-taken, a soft-ware (such as “Agisoft PhotoScan” by Agisoft LLC) in which, by taking a plurality of photos, a 3D profile of the subject is formed from such taken photos, has been developed. The present invention relates to an image taking device which takes image of a full peripheral portion used for forming a 3D profile of the subject to be image-taken.

There exists roughly two objectives for taking image of full periphery of a subject. One objective is to take a photo of space around the image taking person or the image taking device as the subject to be imaged. As such purpose, the image includes a street view by Google Inc. or an image of an automobile taken from every direction. For taking such images, the image taking device includes an omnidirectional camera, wherein a plurality of cameras is provided at every peripheral direction to take the image 360 degree around at one time in maximum or a fisheye camera which takes the image of a particular directional space as wide as possible in a wide-angle. These image taking devices are different from the method of the present invention wherein such conventional device takes the images of the space of the peripheral portion of the space viewed from the center as the subject to be taken.

The second objective is to take the image of outer periphery of a subject to be imaged. The image taking of this purpose is to take the image of outer profile of a human body, a commercial product, a trial product, an art product or an archaeological remains, etc. When taking such products, first, the subject to be image-taken is put on a central position and then a plurality of cameras is fixed around the subject facing towards the subject and then the image of the subject is taken by the plurality of cameras at one time (See Patent Literature 1). As another type, the subject to be image-taken is put on a rotary table and while turning the table, the subject is image-taken by one or more of fixed cameras. (See Patent Literature 2).

On the other hand, as the image processing method of the above mentioned 3D forming Agisoft PhotoScan software, for calculating from the relative distance between the points which are on the surface of the subject, the reference axis, or a reference profile and further different from the stereotype camera using two images, the points both on the subject and the reference must be included in one image and consecutively seventy percentage of the adjacent images must be overlapped. Therefore, when taking these images, a person who takes the images carries the camera and moves carefully around the subject to be image-taken so that the consecutive 70% overlapped image can be obtained. However, the position of the camera which is held by the photographer and the direction thereof are deviated and the image is not consecutive, or the overlapping is short of 70% and as a result, the 3D profile cannot be formed, or a distorted image may be produced frequently.

### CITATION LIST

### Patent Literature

[Patent Literature 1] JP 5966256 B

[Patent Literature 2] JP2003-030635 A

### SUMMARY OF INVENTION

### Technical Problem(s)

One of the issues of the problems is to easily take images of an outer profile of the periphery of the subject to be image-taken consecutively and with seventy percent or more of the taken image being overlapped.

Further, the 3D profile image is used for various purposes and one of them is the use in an archaeological field. Many exploded drawings of the remains such as for example, the earthenware, stone tool, ceramics, etc., are produced. To produce such exploded drawings of the remains, it is necessary to set the X-, Y- and Z-axes to define the position of the front side, upper and lower side planes of the subject.

Accordingly, a second object is to produce axes of coordinates for defining the position of the produced 3D profile.

### Solution to Problem(s)

An image of a subject to be image-taken, which periphery is consecutively taken with seventy percent (%) or more thereof being overlapped, can be obtained by taking the image of the periphery of the subject to be image-taken by an image taking device, stopping per every predetermined rotational angle, while rotating about the subject to be image-taken.

A device for image-taking a full periphery of a subject to be image-taken includes a rotating arm unit which includes a base plate and a rotating arm rotatably attached to the base plate, a subject to be image-taken unit fixed to a central portion of the base plate of the rotating arm unit and on which the subject to be image-taken is placed, an image taking unit which includes an image taking device attached to one end of the rotating arm and rotating together with the rotating arm and a backscreen attached to the other end of the rotating arm and intercepting an image taking of a background behind the subject to be image-taken by the image taking device.

The base plate of the rotating arm unit is placed at a lowermost end and on which a subject to be image-taken unit, an image taking unit, an illumination unit and a backscreen are stably, placed.

The rotating arm unit includes the base plate located at a lower side, the rotating arm located at an upper side and a bearing which connects the base plate and the rotating arm, wherein the rotating arm is freely rotatable on the base plate by means of the bearing. Further, the rotating arm includes a bearing with rotational angle control motor and can be electrically stopped per every predetermined rotational angle. Or, alternatively, the rotating arm can be rotated or stopped manually with reference to an angle indication table attached on the base plate. Still further, in order to fix more stably, the rotating arm can be locked by a rotating angle lock pin per every predetermined angle.

The subject to be image-taken table of the subject to be image-taken unit is attached and fixed to the base plate of the rotating arm unit by a fixing shaft for subject to be image-taken table which passes through the hollow portion of the bearing.

The image taking unit is formed by the image taking device, a height and direction adjustment mechanism for adjusting the image taking device and a transfer mechanism which transfers the image taking device in a front/rear direction. The image taking unit is attached to one end of one side of the rotating arm unit and takes an image of the subject to be image-taken after the rotating arm unit is rotated with a predetermined angle and is stopped. By repeating this image-taking operation, the entire circumferential portion of the subject to be image-taken can be taken.

The illumination unit is attached to the rotating arm unit and illuminates the subject to be image-taken by rotating, always synchronizing with the image taking device. When the surface of the subject to be image-taken has a plurality of even and uneven portions (undulation surface), the illumination unit illuminates the subject to be image-taken everywhere so that a 3D shape with no defect portion exists.

The backscreen is attached to a position behind the subject to be image-taken viewed from the image taking unit side. The backscreen rotates always synchronizing with the image taking device and prevents or intercepts the background image such as walls or ceiling of the image taking place from entering the image to be taken. Thus, the backscreen improves the function of software processing of the 3D shape formation and shortens the processing time therefor.

The posture of the 3D shape to be formed can be set freely by forming the coordinates axes. In order to form such coordinates axes, first, a reference axis is set which sets the X-Y-Z axes about the subject to be image-taken and the reference axis and the subject to be image-taken are image-taken together and using the image processing software, the 3D shape are added onto the coordinates axes.

As the reference axis, the upper side of the front surface (scale) of the subject to be image-taken table is defined to be the X-axis and the upper side of the side surface (scale) is defined to be the Y-axis. Further, the vertical coordinates axis vertical to the subject, to be image-taken table is defined to be the Z-axis. Since the subject to be image-taken is placed on the center of the table, the vertical coordinates axis can be arranged at four corners of the edges of the table or in some cases, any position around the subject to be image-taken.

### Effect of Invention

According to the invention, the subject to be image-taken can be consecutively and with 70% or more overlapping plurality of adjacently positioned images image-taken by a full periphery image taking device and an accurate 3D shape with no defecting portion can be formed using 3D shape formation software.

According to the invention, the subject to be image-taken can be image-taken by a full periphery image taking device and a 3D shape arrangement can be set which includes X-Y-Z axes using the 3D shape formation software.

### BRIEF EXPLANATION OF ATTACHED DRAWINGS

FIG. 1 is an upper side view of the subject to be image-taken full periphery image taking device;

FIG. 2 is a side view of the subject to be image-taken full periphery image taking device;

FIG. 3 is a view of rotating arm unit with rotational angle control motor;

FIG. 4 is a view of rotating arm unit with rotational angle lock pin;

FIG. 5 is a view of image taking unit;

FIG. 6 is a front view of the subject to be image-taken viewed in each rotational angle;

FIG. 7 is a subject to be image-taken unit with both side vertical coordinates axes;

FIG. 8 is a subject to be image-taken unit with four corner vertical coordinates axes;

FIG. 9 is a subject to be image-taken unit with diagonal arrangement of vertical coordinates axes;

FIG. 10 is a view of 3D shape including X-Y-Z axes; and

FIG. 11 is an exploded view of the 3D shape arranged using X-Y-Z axes.

### EMBODIMENTS FOR IMPLEMENTING INVENTION

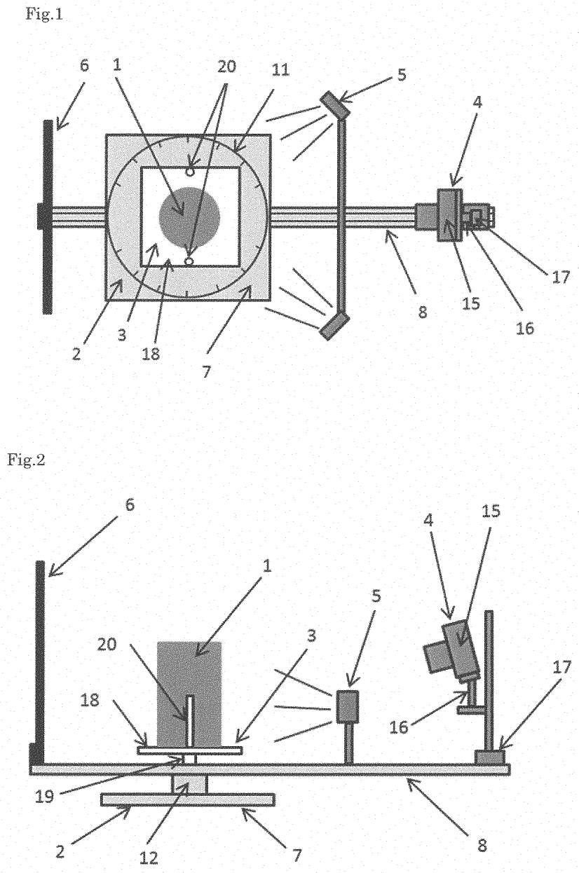

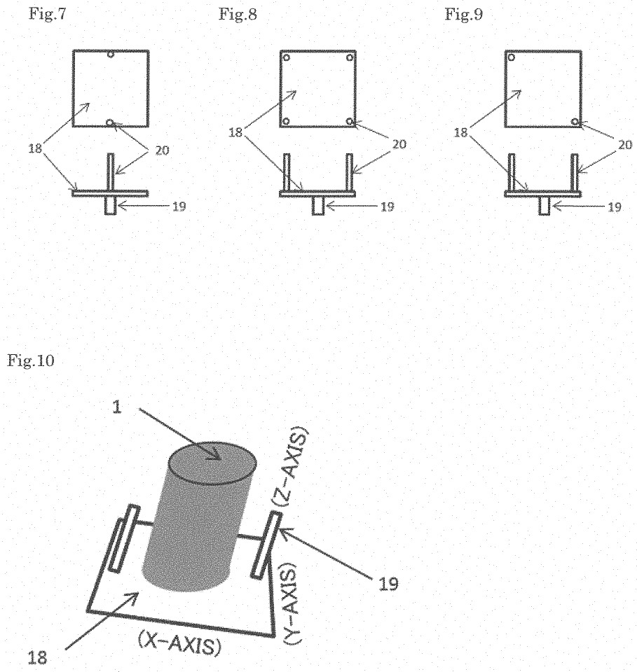

The subject to be image-taken 1 is placed on the subject to be image-taken table 16 adjusting the position so that the front side of the subject 1 agrees with the zero position of the rotational angle indicating plate 11 as shown in FIG. 1. The vertical coordinates axis 20 is arranged at both sides as shown in FIG. 7.

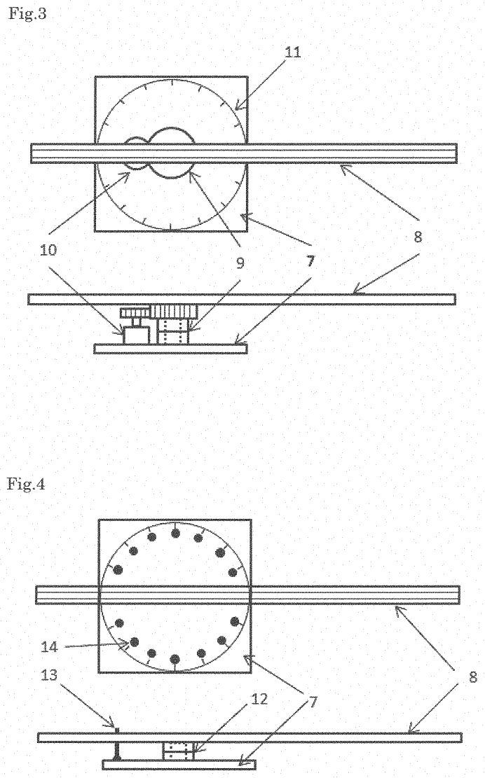

Next, the rotating arm 8 shown in FIG. 3 or 4 is rotated with a necessary angle. In order to satisfy the conditions of image taking, i.e., that the image is taken consecutively with 70% or more overlapping adjacently positioned images, that the rotating arm 8 is rotated with a fixed angle which is 54 degrees obtained by the following Formula 1.

Rotating angle<180 degree×(100%−70%)/100=54 degrees (Formula 1)

Wherein the camera viewing filed is 180 degree.

Accordingly, for example, the arm 8 is rotated with the angle of 45 degree consecutively, and eight sheet images can be taken to be able to take the full periphery subject image with 70% or more overlapping adjacently positioned images.

There are two patterns of rotating the rotating arm 8. One pattern is to electrically rotate and stop the rotating angle 8 with gear rotational angle control motor 10 as shown in FIG. 3 and the second pattern is to manually rotate the rotating arm 8 with a preset angle worth with reference to the rotating angle indicating plate attached on the base plate 7 as shown in FIG. 4. Thus, by inserting the rotating angle lock pin 13 in the lock pin fixing recess 14 provided on the base plate 7 every predetermined angle, the rotating arm 8 can be fixed. In any pattern above, the first image is taken by the image taking device 15 to agree the front position of the subject 1 with the zero position of the rotating angle indicating plate 11 and thereafter, the rotating arm 8 is rotated per every predetermined angle in turn and stopped for image taking.

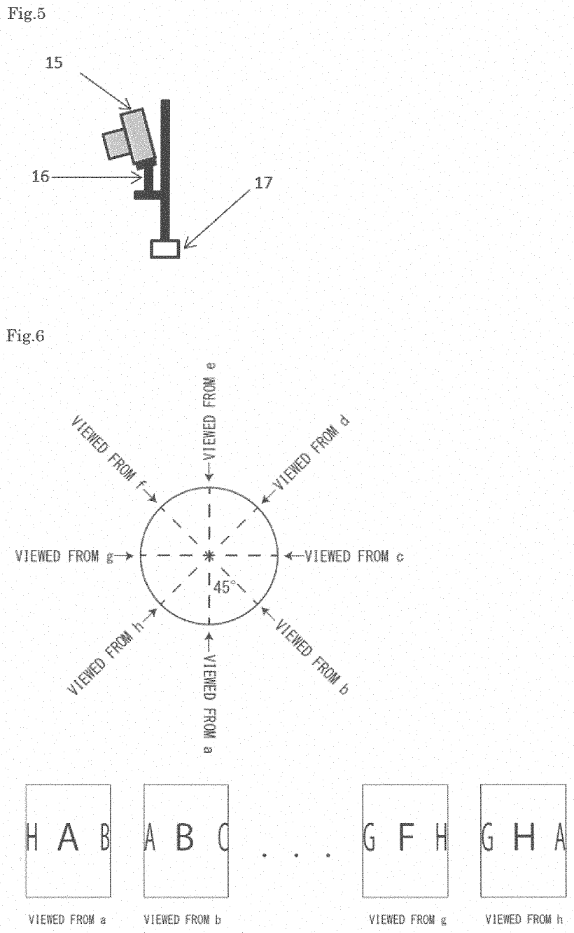

The image taking device 15 shown in FIG. 5 takes the images of the subject 1. The position of the image taking device 15 relative to the subject 1 is optimally adjusted considering the size and shape of the subject 1. The adjustment of the height and the direction is made by a height and direction adjusting device and the adjustment of the distance from the subject is made by a front rearward transfer movement adjusting device 17 which moves along the groove of the rotating arm and the outer profile.

FIG. 6 shows a full periphery image of the subject 1 to be image taken which is taken by the method explained above. For example, in a cylindrical shaped subject, characters A through H are written on the side surface of the cylindrical shaped subject at equally divided one-eighth positions and when the subject 1 is image-taken by rotating image-taking device 15 consecutively with 45 degree, eight images viewed from the “a” arrow through “h” arrow can be obtained. The overlapping, ratio of the adjacently positioned images can be obtained by the formula: (45°×3)/180°=75%. Thus, 70% or more of the overlapping images can be obtained.

The vertical coordinates axis 20 is provided on the table 18. The number of the vertical coordinates axes is at least one, however, as shown in FIGS. 7 and 8, two at both sides of the subject 1 or four at the four corners of the subject 1, or as shown in FIG. 9, two at front and back sides of the subject are arranged, which will be convenient for controlling the posture of the 3D shape in the later processing.

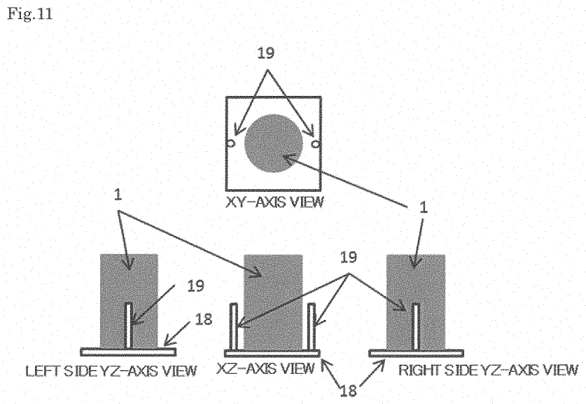

The subject 1 to be image-taken is placed on the center of the table 18 in a rectangular or square shape, as shown in FIG. 1 and then the subject 1 is image-taken to obtain the images taken with the table 18 and the vertical coordinates axis 20, Then, such taken images are processed by the 3D shape formation software to form the 3D shape of the subject in which the vertical coordinates axes 20 are included as shown in FIG. 10. The upper side of front surface (scale) of the table 18 is defined to be the X-axis the upper side of the side surface (scale) of the table 18 and the vertical coordinates axis 20 is defined to be the Z-axis in the 3D shape subject. Then, in the space enclosed by the X-Y-and Z-axes, the 3D shape can be freely set as shown in FIG. 11 to be able to form respective exploded views of each axis side surface.

If the subject 1 has undulations on the surface, the illumination only from the ceiling light of the room may generate a shadow at a portion of the subject 1 and accordingly, depending on the situation, the illumination unit 5 is used as shown in FIG. 1. The illumination unit 5 is attached to the rotating arm unit 2 and with synchronization with the transfer movement of the image taking device 15, the illumination unit 5 always illuminates the subject 1.

Normally, the background behind the subject 1 may not be necessary for 3D shape formation and therefore, as shown in FIG. 1, a backscreen 6 is provided at the rear side of the subject 1. The backscreen 6 is attached to the rotating arm unit 2 and with synchronization with the transfer movement of the image taking device 5, the background of the subject 1 is always not image-taken.

### REFERENCE SIGNS LIST

1: subject to be image-taken, 2: rotating arm unit, 3: subject to be image-taken unit, 4: image taking unit, 5: illumination unit, 6: backscreen, 7: base plate, 8: rotating arm, 9: bearing with gear mechanism, 10: rotating angle control motor with gear mechanism, 11: rotating angle indicating plate, 12: bearing, 13: rotating angle lock pin, 14: lock pin fixing recess, 15: image-taking device, 16: height and direction adjusting device, 17: front/rearward transfer movement adjusting device, 18: subject to be image-taken table, 19: fixing shaft for subject to be image-taken table, 20: vertical coordinates axis.

1. An image taking device for taking full periphery of a subject to be image-taken comprising:
a rotating arm unit having a base plate and a rotating arm which is rotatably attached to the base plate;
a subject to be image-taken unit fixed to a central portion of the base plate of the rotating arm unit and positioning the subject to be image taken thereon;
an image taking unit including an image taking device attached to one end of the rotating arm and rotatable with the rotating arm; and
a backscreen attached to the other end of the rotating arm so that a background of the subject to be image-taken is interrupted from image taking by the image taking device.

2. The image taking device for taking full periphery of a subject to be image-taken according to claim 1, wherein,
the image taking unit includes a position adjustment device which adjusts a position of the image taking device relative to the subject to be image-taken.

3. The image taking device for taking full periphery of a subject to be image-taken according to claim 1 wherein,
the position adjustment device includes a front/rearward transfer movement adjusting device which adjusts a distance from the subject to be image-taken and a height and direction adjusting device which adjusts a height and a direction of the image taking device.

4. The image taking device for taking full periphery of a subject to be image-taken according to claim 1, wherein,
the rotating arm of the rotating arm unit rotates about a periphery of the subject to be image-taken unit fixed to the base plate of the rotating arm unit.

5. The image taking device for taking full periphery of a subject to be image-taken according to claim 1, wherein,
the rotating arm unit is rotated and stopped per every fixed interval rotating angle by means of a rotating angle control motor or manually.

6. The image taking device for taking full periphery of a subject to be image-taken according to claim 1, wherein,
the image taking device attached to one end of one side rotating arm unit takes the image of the subject to be image-taken by rotating with the rotating arm unit in always synchronization therewith.

7. The image taking device for taking full periphery of a subject to be image-taken according to claim 1, wherein,
an illumination unit attached to the rotating arm unit illuminates the subject to be image-taken by rotating with the image taking device in always synchronization therewith.

8. The image taking device for taking full periphery of a subject to be image-taken according to of claim 1, wherein,
the backscreen attached to one end of the other side of the image taking device of the rotating arm unit prevents an image taking of background other than the image of the subject to the image-taken by rotating with the image taking device in always synchronization therewith.

9. The image taking device for taking full periphery of a subject to be image-taken according to claim 1, wherein,
the subject to be image-taken unit is formed by a subject to be image-taken table which includes a rectangular or a square shape formed with X-axis and Y-axis and a vertical coordinates axis forming a Z-axis.
